(19) United States
(12) Patent Application Publication
(10) Pub. No.: US 2025/0368212 A1
(43) Pub. Date: Dec. 4, 2025

(54) INTEGRITY VERIFICATION OF VEHICLE CONTROL SYSTEMS

(71) Applicant: RM ACQUISITION, LLC, Boise, ID (US)

(72) Inventors: Andreas Kuehnle, Boise, ID (US); Nicholas A. Broyles, Boise, ID (US); Justin Miller, Boise, ID (US)

(21) Appl. No.: 19/223,755

(22) Filed: May 30, 2025

Related U.S. Application Data
(60) Provisional application No. 63/654,321, filed on May 31, 2024.

(51) Int. Cl. B60W 50/00; B60W 50/04; B60W 50/14

(52) U.S. Cl. CPC B60W 50/0098; B60W 50/045; B60W 50/14; B60W 2420/403; B60W 2510/0638; B60W 2520/105; B60W 2520/28; B60W 2540/12; B60W 2540/18

(57) ABSTRACT

System, methods, and computer readable mediums provide integrity verification apparatus operable in an associated vehicle to verify the integrity of control device components interfacing a vehicle controller of the associated vehicle with a physical environment of the associated vehicle. The integrity of first and second control device components is verified based on a match within a predetermined range between a second signal that is predicted using a dynamic vehicle model and a second observed signal obtained for a given first signal directed to the associated vehicle. A verification refute signal is generated based on a mismatch within a predetermined range between the predicted second signal and the second observed signal, wherein the verification refute signal is used by the vehicle controller to adjust a functional aspect of the associated vehicle.

### CROSS-REFERENCE TO RELATED APPLICATION

This application claims priority to U.S. Provisional Patent Application No. 63/654,321, entitled “Integrity Verification of Vehicle Control Systems,” filed May 31, 2024, the entire disclosure of which is incorporated herein by reference in its entirety.

### TECHNICAL FIELD

The present disclosure relates to integrity verification of vehicle control systems. Although the examples will be described in connection with systems and methods that provide integrity verification of control systems including automated driver assist systems of commercial fleet vehicles, it is to be appreciated that the embodiments are usable and may be applied to any moving vehicle including for example passenger cars, construction and agricultural vehicles, and the like, and may further be used in a wide range of other applications including for example with any type of machine that may operate automatically as well as those that are controlled by an operator and those that are controlled using operator assistance functionalities.

### BACKGROUND

Systems are available for collecting operational data and video data from a vehicle during operation of the vehicle. The information that is collected may be stored locally onboard the vehicle where it may be analyzed and/or transmitted or otherwise communicated to a remote processing center where the analysis may take place. One such system known as SafetyDirect® by Bendix Commercial Vehicle Systems LLC is a world-renowned leading example and has been widely adopted. With data delivered by the SafetyDirect® system, vehicle fleet operators and managers are able to assess driving records, develop targeted driver training that addresses possible issues that take place on the road, and make other business management decisions that help to effect improved performance and overall efficiency of drivers and vehicle fleet usage.

The SafetyDirect® system records events produced by signals obtained from various sensors including for example accelerometers, distance sensors, and video sensors such as cameras for example. The SafetyDirect® system is particularly useful in recording events produced by signals obtained when it is determined that those signals are above and/or below predetermined thresholds or within predetermined ranges that might be produced as a result of various undesirable vehicle operational events such as for example excessive braking events, unwanted lane departure events, insufficient headway events, etc. The event recordings may include sensor data, video image data, and/or other data that is representative of the vehicle operations of the event before, during and after the event (i.e., pre- and post-event (PPE) data) and the vehicle/driver signals/dynamics obtained during the event (brake pressure, steering angle, speed, deceleration, location, etc.).

In addition, the SafetyDirect® system may be integrated with an electronic control unit (ECU) of a host vehicle and used as or in conjunction with an Advanced Driver Assistance System (ADAS). In this way, the ADAS functionality of the SafetyDirect® system may be used to help to improve vehicle efficiency and driver safety by providing important information to the driver such as warning information in the form of audible, visual, and/or tactile warnings, wherein the information that is provided may be based on information collected from on-board equipment that include sensors including for example radar, sonar, light/laser detection and ranging (LIDAR) sensors, and cameras. Operator assistance of this type may include such functions as lane departure warning (LDW) functionality, rear collision warning (RCW) functionality, blind spot detection (BSD) functionality, traffic sign recognition (TSR) functionality, and others. In addition to providing passive information and warnings, other ADAS functionalities may further include active vehicle control and/or driver interventions such as for example control of the vehicle using adaptive cruise control (ACC), automatic emergency braking (AEB), and many more.

Because driver assist systems such as the SafetyDirect® system described above may at times be granted either partial control of the vehicle or full control of the vehicle, or at times may operate to inadvertently excite the driver with possibly distracting audible, visual, and/or tactile warnings, it is desirable to verify that the underlying sensors within the vehicle upon which these systems use as inputs for making decisions regarding effecting full and/or partial control of the vehicle are fully functional and properly calibrated.

Similarly, it is desirable to verify that the underlying vehicle operational circuits and systems within the vehicle such as for example steering and braking systems upon which these systems use as outputs for effecting decisions regarding the full and/or partial control of the vehicle are fully functional and properly calibrated.

### SUMMARY

Described herein are systems, methods and computer readable mediums that are executable to verify the integrity of control systems in vehicles that interface the vehicles with physical environments of the vehicles.

Described herein are systems, methods and computer readable mediums that are executable to verify the integrity of control systems that include movement effector systems in vehicles and feedback sensor systems in vehicles.

Described herein are systems, methods and computer readable mediums that are executable to verify the integrity of control devices interfacing a vehicle with an environment of the vehicle.

Further described herein are systems, methods and computer readable mediums that are executable to verify the integrity of control system sensors in vehicles.

Further described herein are systems, methods and computer readable mediums that are executable to verify the integrity of operational circuits and systems in vehicles.

Further described herein are systems, methods and computer readable mediums that are executable to verify the integrity of combined control system sensors and operational circuits and systems in vehicles.

In accordance with an aspect, the disclosure herein relates to an integrity verification apparatus that is operable in an associated vehicle to verify the integrity of control device components interfacing a vehicle controller of the associated vehicle with a physical environment of the associated vehicle. The integrity verification apparatus includes a processor device, a non-transitory memory device operatively coupled with the processor device, a dynamic vehicle model stored in the non-transitory memory device, and integrity verification logic stored in the non-transitory memory device. The dynamic vehicle model includes vehicle operational state data representative of normal operational states of the vehicle controller, wherein a first normal operational state maps a verified first signal obtained from a first control device component of the associated vehicle for the vehicle controller being operated in the first normal operational state to a verified second signal obtained from a second control device component of the associated vehicle for the vehicle controller being operated in the first normal operational state. The processor device is operable to execute the integrity verification logic to receive a first observed signal from the first control device component of the associated vehicle for the vehicle controller being operated in the first normal operational state, and use the dynamic vehicle model to map the received first observed signal to a predicted second signal expected to be obtained from the second control device component for the vehicle controller being operated in the first normal operational state. The processor device is operable to execute the integrity verification logic to compare the predicted second signal with a second observed signal received from the second control device component, and verify the integrity of the first and second control device components based on a match within a predetermined range between the predicted second signal and the second observed signal, or generate a verification refute signal based on a mismatch within a predetermined range between the predicted second signal and the second observed signal, wherein the verification refute signal is used by the vehicle controller to adjust a functional aspect of the associated vehicle.

In any of the embodiments herein, the processor device of the integrity verification apparatus is operable to execute the integrity verification logic to generate the verification refute signal based on the mismatch within a predetermined range between the predicted second signal and the second observed signal, wherein the verification refute signal is used by the vehicle controller to adjust one or more of a content of a warning signal generated by the vehicle controller for warning the driver of potential danger relating to the vehicle operation, a timing of a warning signal generated by the vehicle controller for warning the driver of potential danger relating to the vehicle operation, a format of a warning signal generated by the vehicle controller for warning the driver of potential danger relating to the vehicle operation, a style of a warning signal generated by the vehicle controller for warning the driver of potential danger relating to the vehicle operation, and/or a parameter of one or more automatic driver assistance systems (ADASs) of the associated vehicle

In any of the embodiments herein, the processor device of the integrity verification apparatus is operable to execute the integrity verification logic to receive image data as the first observed signal from the first control device component comprising an imaging device, and receive sensor data as the second observed signal from the second control device component comprising one or more of an accelerometer, a steering wheel angle position sensor, a brake pedal position sensor, a wheel speed sensor, a forward distance sensor, a rear distance sensor, and/or an engine speed or condition sensor.

In any of the embodiments herein, the processor device of the integrity verification apparatus is operable to execute the integrity verification logic to receive driver image data as the first observed signal from the first control device component comprising an imaging device oriented to obtain an image of the driver of the associated vehicle, and receive sensor data as the second observed signal from the second control device component comprising one or more of an accelerometer, a steering wheel angle position sensor, a brake pedal position sensor, a wheel speed sensor, a forward distance sensor, a rear distance sensor, and/or an engine speed or condition sensor.

In any of the embodiments herein, the processor device of the integrity verification apparatus is operable to execute the integrity verification logic to receive roadway image data as the first observed signal from the first control device component comprising an imaging device oriented to obtain an image of the roadway ahead of the associated vehicle, and receive sensor data as the second observed signal from the second control device component comprising one or more of an accelerometer, a steering wheel angle position sensor, a brake pedal position sensor, a wheel speed sensor, a forward distance sensor, a rear distance sensor, and/or an engine speed or condition sensor.

In any of the embodiments herein, the processor device of the integrity verification apparatus is operable to execute the integrity verification logic to generate the verification refute signal based on the mismatch within a predetermined range between the predicted second signal and the second observed signal, wherein the verification refute signal is used by the vehicle controller to terminate operation of one or more automatic driver assistance systems (ADASs) of the associated vehicle, execute operation of the one or more ADASs of the associated vehicle in a reduced manner, and/or initiate a correction in the one or more ADASs of the associated vehicle.

The various examples described above can be combined with each other in further examples.

It is to be understood that the features mentioned above and those yet to be explained below may be used not only in the respective combinations indicated, but also in other combinations or in isolation without departing from the scope of the invention.

Other aspects, embodiments, features and advantages of the example embodiments will become apparent from the following description of the embodiments, taken together with the accompanying drawings, which illustrate, by way of example, the principles of the example embodiments.

### BRIEF DESCRIPTION OF THE DRAWINGS

In the accompanying drawings which are incorporated in and constitute a part of the specification, embodiments of the invention are illustrated, which, together with a general description of the implementations given above, and the detailed description given below, serve to exemplify the embodiments of this disclosure.

FIG. 1 is a schematic block diagram depiction that illustrates details of a vehicle control apparatus disposed in a representative associated vehicle in accordance with an example embodiment.

FIG. 2 illustrates is a schematic functional block diagram of an integrity checking system according to an example embodiment.

FIG. 3 is a flow diagram illustrating a method of developing a dynamic vehicle model in accordance with an embodiment.

FIG. 4 is a pictorial illustration showing a method of developing a dynamic vehicle model in accordance with an embodiment.

### DETAILED DESCRIPTION OF THE EXAMPLE EMBODIMENTS

In the following description of the present invention reference is made to the accompanying drawing Figures which form a part thereof, and in which are shown, by way of illustration, exemplary embodiments illustrating the principles of the disclosed integrity verification systems and methods, and how the embodiments are practiced. Other embodiments can be utilized to practice the disclosed methods and systems to verify the integrity of control device components interfacing a vehicle controller of the associated vehicle with a physical environment of the associated vehicle, and selectively adjusting one or more functional aspects of the associated vehicle based on the results of the integrity verification.

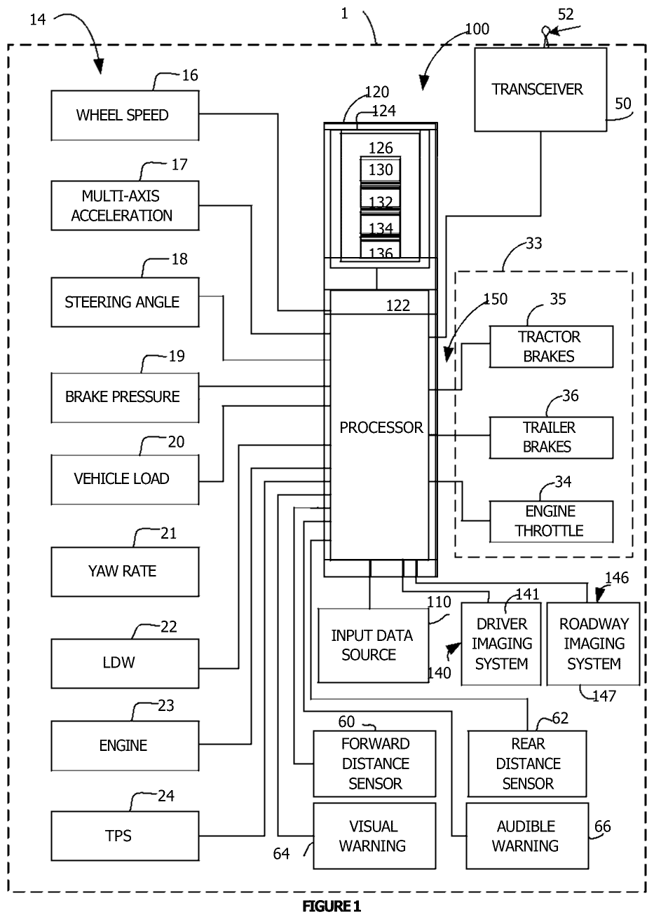

Referring now to the drawings, wherein the showings are for the purpose of illustrating the example embodiments only, and not for purposes of limiting the same, FIG. 1 illustrates an overview of a system 100 configured to verify the integrity of control device components interfacing a vehicle controller of the associated vehicle with a physical environment of the associated vehicle, and selectively adjusting one or more functional aspects of the associated vehicle based on the results of the integrity verification in accordance with an example embodiment of the present disclosure. In this example embodiment, vehicles 1, such as trucks and cars, and particularly fleet vehicles in accordance with an example implementation may be configured with one or more driving assessment and assistance systems which may comprise an in-vehicle computing system that generates actual data relating to driving and vehicle events that may be of interest to a fleet manager or other user. Such a system may include for example a lane departure warning (LDW) system 22 that may generate signals indicative of an actual lane departure, such as lane wandering or crossing. Additionally, secondary systems to be described in greater detail below may be carried by the vehicles or installed in the vehicle systems, including one or more video cameras, radar, light detection and ranging (LIDAR), transmission, engine, tire pressure monitoring and braking systems, for example, that may generate additional safety event data and driver behavior data. Front facing cameras, radar and LIDAR-based system may also be used to provide data relating to driver behavior in the context of following distance, headway time, response to speed signs, and anticipation of needed slowing. In accordance with the example embodiments, the driving assessment and assistance systems may record events produced by signals when it is determined that those signals are above or below predetermined thresholds or within predetermined ranges that might be produced as a result of various vehicle operational events such as for example excessive braking events, unwanted lane departure events, insufficient headway events, etc. The event recordings may be saved as event data and may include sensor data, video image data, and/or other data that is representative of the vehicle operations of the event such as for example PPE data, and the vehicle/driver signals/dynamics during the event (brake pressure, steering angle, speed, deceleration, location, etc.). In accordance with the example embodiments, the driving assessment and assistance systems may receive event data from one or more other system(s) of the vehicle such as from a SafetyDirect® system or the like.

In the embodiments herein, the vehicle control apparatus 100 monitors the behavior of drivers operating vehicles while also verifies the integrity of control device components interfacing a vehicle controller of the associated vehicle with a physical environment of the associated vehicle, and selectively adjusting one or more functional aspects of the associated vehicle based on the results of the integrity verification. In an embodiment, the vehicle control apparatus 100 monitors the behavior of drivers operating vehicles taking into consideration physical characteristics of the vehicle during various vehicle maneuvers and determined driver behavior during the maneuvers. Particular embodiments further relate to using results of the monitoring the behavior for enhancing the safety of the vehicles and for helping to improve the performance of the drivers.

In an embodiment, the vehicle control apparatus 100 verifies the integrity of control device components interfacing a vehicle controller of the associated vehicle with a physical environment of the associated vehicle, and selectively adjusts one or more functional aspects of the associated vehicle based on the results of the integrity verification taking into consideration head pose conditions of the driver and other characteristics of the driver while operating the vehicle. In the embodiments herein, the vehicle control apparatus 100 monitors the behavior of drivers operating vehicles based on monitoring a head pose condition of the driver during the operation of the vehicle, together with monitoring one or more physical characteristics of the vehicle during the operation. In the embodiments herein, the vehicle control apparatus 100 monitors the behavior of drivers operating vehicles based on monitoring a head pose condition of the driver during a maneuver of the vehicle, together with monitoring one or more physical characteristics of the vehicle during the maneuver. In the embodiments herein, the vehicle control apparatus 100 monitors the behavior of drivers operating vehicles based on monitoring a head pose condition of the driver during a plurality of different maneuvers of the vehicle, together with monitoring one or more physical characteristics of the vehicle during the plurality of different maneuvers. In the embodiments herein, the vehicle control apparatus 100 verifies the integrity of control device components interfacing a vehicle controller of the associated vehicle with a physical environment of the associated vehicle, and selectively adjusts one or more functional aspects of the associated vehicle based on the results of the integrity verification. In some embodiments herein, the vehicle control apparatus 100 verifies the integrity of control device components interfacing a vehicle controller of the associated vehicle with a physical environment of the associated vehicle, and selectively adjusts one or more functional aspects of the associated vehicle based on the results of the integrity verification during one or more maneuvers of a vehicle, wherein one or more functional aspects of the vehicle may be adjusted based on the determined integrity check during the one or more maneuvers. In the embodiments herein, the vehicle control apparatus 100 verifies the integrity of control device components interfacing a vehicle controller of the associated vehicle with a physical environment of the associated vehicle, and selectively adjusts one or more functional aspects of the associated vehicle based on the results of the integrity verification during a plurality of maneuvers of a vehicle as an integrity check trend over a period of time as the monitored behavior, wherein a functional aspect of the vehicle may be adjusted based on the determined driver integrity verification trend during the plurality of maneuvers.

In the exemplary embodiment of FIG. 1, the control apparatus 100 may interact with one or more devices or systems 14 for providing input data indicative of one or more operating parameters or one or more conditions of the vehicle 1. For example, the devices may be one or more sensors, such as but not limited to, one or more wheel speed sensors 16, one or more acceleration sensors such as multi-axis acceleration sensors 17, a steering angle sensor 18, a brake pressure sensor 19, one or more vehicle load sensors 20, a yaw rate sensor 21, a lane departure warning (LDW) sensor or system 22, one or more engine speed or condition sensors 23, and a tire pressure (TPMS) monitoring system 24. In the example embodiment illustrated, the control apparatus 100 may interact with one or more additional devices or systems in particular that provide input data indicative of one or more additional operating parameters or one or more conditions of the vehicle 1 such as for example, a forward distance sensor 60, and a rear distance sensor 62. Other sensors and/or actuators or power generation devices or combinations thereof may be used or otherwise provided as well, and one or more devices or sensors may be combined into a single unit as may be necessary and/or desired.

In addition and in the exemplary embodiment of FIG. 1, the control apparatus 100 may interact with one or more further devices or vehicle systems 33 for adjusting one or more functional aspects of the vehicle based on determined integrity check of the control device components interfacing a vehicle controller of the associated vehicle with a physical environment of the associated vehicle during operation of the vehicle 1 such as for example during one or more maneuvers, and also for example for adjusting one or more functional aspects of the vehicle based on the results of the integrity checking during a plurality of maneuvers of a vehicle as an integrity check trend over a period of time. The control apparatus 100 may interact with one or more further devices or vehicle systems 33 for adjusting braking functional aspects of the vehicle, throttle functional aspects of the vehicle, and/or steering functional aspects of the vehicle based on determined integrity checking during operation of the vehicle 1. In addition, the control apparatus 100 may interact with the driver using functional aspects of the vehicle by providing visual warnings to the driver via a visual warning device 64 and/or by providing audible warnings to the driver via an audible warning device 66.

The control apparatus 100 of the example embodiment includes an electronic control unit (ECU) 120 operatively coupled with the one or more devices or systems 14 described above. The control apparatus 100 is also coupled in the example embodiment with an input data source 110, a driver imaging system 140, and a roadway imaging system 146. The ECU 120 is in general configured to receive vehicle control signals from an input data source 110 to effect various operations in the associated vehicle 1. In the implementation, the ECU 120 includes a processor device 122, a non-transitory memory device 124 operatively coupled with the processor device 122, and vehicle control logic 126 stored in the memory device 124. The vehicle control logic 126 is executable by the processor device 122 to generate vehicle control signals 150 to perform various control operations including for example braking and throttle control operations in the associated vehicle 1 based on execution of the logic 126 by the processor device 122 during operation of the vehicle 1. In an implementation and as will be described in greater detail herein, the vehicle control logic 126 may include one or more of a dynamic vehicle model 130, integrity verification logic 132, neural network logic 134, and/or flagging determination logic 136, all of which are stored in the memory device 124.

In the example embodiment illustrated and described herein, the processor 122 may include one or more inputs for receiving input data from the devices or systems 14, and one or more outputs for communicating signals to the one or more devices or vehicle systems 33 for adjusting one or more functional aspects of the vehicle based on determined integrity checking during operation of the vehicle 1. The processor device 122 may be adapted to process the input data and compare the raw or processed input data to one or more stored threshold values, or to process the input data and compare the raw or processed input data to one or more circumstance-dependent desired value. The processor device 122 may also include one or more outputs for delivering control signals 150 to one or more vehicle systems 33 based on the comparison. The control signals 150 may instruct the systems 33 to intervene in the operation of the vehicle to initiate corrective action, and then report this corrective action to a wireless service (not shown) or simply store the data locally to be used for determining a driver quality. For example, the processor device 122 may generate and send the control signal to an engine electronic control unit or an actuating device to reduce or otherwise retard or close the engine throttle 34 and slowing the vehicle down (decelerating the vehicle). In addition, the processor device 122 may generate and send the control signal to the engine electronic control unit or an actuating device to increase or otherwise advance or open the engine throttle 34 and speeding the vehicle up (accelerating the vehicle). Further, the processor device 122 may send the control signals to one or more vehicle brake systems 35, 36 to selectively engage the brakes. In a tractor-trailer arrangement of the example embodiment, the processor device 122 may engage the brakes 36 on one or more wheels of a trailer portion of the vehicle via a trailer pressure control device (not shown), and the brakes 35 on one or more wheels of a tractor portion of the vehicle 1, and then report this corrective action to the wireless service or simply store the data locally to be used for determining a driver quality. A variety of corrective and/or other actions may be possible and multiple corrective actions may be initiated at the same time. In addition, any of the operating parameters of the vehicle such as, for example, operating parameters of any of the one or more devices or vehicle systems 33 including also for example any of the preexisting systems in the vehicle such as for example advanced antilock brake control systems and/or electronic stability control systems, may be adjusted based on the determined driver behavior. The control apparatus 100 may interact with one or more further devices or vehicle systems 33 for adjusting braking functional aspects of the vehicle, throttle functional aspects of the vehicle, and/or steering functional aspects of the vehicle based on determined integrity verification during operation of the vehicle 1. In addition, the control apparatus 100 may interact with the driver using functional aspects of the vehicle by providing visual warnings to the driver via a visual warning device 64 and/or by providing audible warnings to the driver via an audible warning device 66.

In addition, the processor device 122 may generate and send one or more control signals to the visual warning device 64 and/or to the audible warning device to provide visual and/or audible warnings to the driver via these devices 64, 66.

The sensors 14 and ECU 120 may be part of a preexisting system or use components of a preexisting system. For example, the Bendix® ABS-6™ Advanced Antilock Brake Controller with ESP® Stability System commercially available from Bendix Commercial Vehicle Systems LLC may be installed on the vehicle. The Bendix® ESP® system may utilize some or all of the sensors described in FIG. 1. The logic component of the Bendix® ESP® system resides on the vehicle's antilock brake system electronic control unit, which may be used for the processor 122 of the present invention. Therefore, many of the components to support the vehicle control apparatus 100 of the present disclosure may be present in a vehicle equipped with the Bendix® ESP® system, thus, not requiring the installation of additional components. The vehicle control apparatus 100, however, may utilize independently installed components if desired. Further, an IMX.6 processor separate from the ESP system may execute the functions described herein.

The vehicle control apparatus 100 may also include additional sources of input data including for example an input from a forward distance sensor 60 that generates a signal indicative of a distance to a vehicle ahead of the vehicle 1, and a rear-facing sensor 62 that generates a signal representative of a distance to a vehicle behind of the vehicle 1. The vehicle control apparatus 100 may generate a signal to actuate a visual warning device 64 for visually alerting the driver of a potential event that might need attention such as for example a visual warning of an impending forward collision permitting the driver to react by applying brakes, for example, or visual warning of an impending rearward collision permitting the driver to react prior to a collision while backing up the vehicle. The vehicle control apparatus 100 may similarly generate an audible signal to actuate an audible warning device 66 for audibly alerting the driver of a potential event that might need attention such as for example an audible annunciation of a warning of an impending forward collision permitting the driver to react by applying brakes, for example, or an audible annunciation of an impending rearward collision permitting the driver to react prior to a collision while backing up the vehicle.

In addition, the control apparatus 100 is operatively coupled with a driver imaging system 140 that may comprise one or more imaging devices shown in the example embodiment for simplicity and ease of illustration as a single driver facing camera 141 representation of one or more physical video cameras disposed on the vehicle such as, for example, a video camera in operative communication with the control apparatus 100 and disposed in the cab of a commercial vehicle directed so as to obtain an image of the driver. In addition, the control apparatus 100 is operatively coupled with the roadway imaging system 146 shown in the example embodiment for simplicity and ease of illustration as a single forward-facing camera (FFC) 147 disposed on the vehicle in a manner to record images of the roadway ahead of the vehicle, or, as in the example embodiment. It is to be appreciated that the roadway imaging system 146 may comprise a plurality of cameras including one or more FFCs, and one or more rear and/or side facing cameras (RFCs) as may be desired. The roadway imaging system 146 may comprise cameras disposed in general at all four corners of the vehicles such as to provide a 360° surround image of the roadway ahead of the vehicle as well as behind and to the left and right sides. In the example embodiments, driver behavior is monitored directly using the driver facing camera 141 in accordance with a detected head position of the driver within the vehicle being operated by the vehicle, the details of which will be elaborated below. In further example embodiments, the driver behavior is monitored directly using the driver facing camera 141 in accordance with a detected head pose of the driver. For purposes of this description of the example embodiments and for ease of reference, “head pose” is that set of angles describing the orientation of the driver's head, that is, pitch (driver looking down or up), yaw (driver looking left or right), and roll (driver tilting his/her head to the left or right). In still further embodiments, driver behavior is monitored indirectly using the driver facing camera 141 in accordance with detected aspects of components of the vehicle being operated by the driver, the details of which will be elaborated below. The driver facing camera 141 may include an imager available from Ominivision™ as part/model number 10635, although any other suitable equivalent imager may be used as necessary or desired.

In the example embodiment illustrated and described herein, the control apparatus 100 may deliver control signals 150 to one or more vehicle systems 33 based also on the determined integrity check results. The control signals 150 may instruct the systems 33 to intervene in the operation of the vehicle to initiate corrective action based on the determined integrity check results, and then report this corrective action to a wireless service (not shown) or simply store the data locally to be used for determining a driver quality. For example, the processor device 122 may generate and send the control signal to an engine electronic control unit or an actuating device to reduce or otherwise retard or close the engine throttle 34 and slowing the vehicle down (decelerating the vehicle) based on the determined integrity check results. In addition, the processor device 122 may generate and send the control signal to the engine electronic control unit or an actuating device to increase or otherwise advance or open the engine throttle 34 and speeding the vehicle up (accelerating the vehicle) based on the determined integrity check results. Further, the processor device 122 may send the control signals to one or more vehicle brake systems 35, 36 to selectively engage the brakes based on the determined integrity check results. In a tractor-trailer arrangement of the example embodiment, the processor device 122 may engage the brakes 36 on one or more wheels of a trailer portion of the vehicle via a trailer pressure control device (not shown), and the brakes 35 on one or more wheels of a tractor portion of the vehicle 1 based on the determined integrity check results, and then report this corrective action to the wireless service or simply store the data locally to be used for determining integrity check results. A variety of corrective and/or other actions may be possible and multiple corrective actions may be initiated at the same time based on the determined integrity check results. In addition, any of the operating parameters of the vehicle such as, for example, operating parameters of any of the one or more devices or vehicle systems 33 including also for example any of the preexisting systems in the vehicle such as for example advanced antilock brake control systems and/or electronic stability control systems, may be adjusted based on the determined integrity check results. The control apparatus 100 may interact with one or more further devices or vehicle systems 33 for adjusting braking functional aspects of the vehicle, throttle functional aspects of the vehicle, and/or steering functional aspects of the vehicle based on determined integrity check results during operation of the vehicle 1. In addition, the control apparatus 100 may interact with the driver using functional aspects of the vehicle by providing visual warnings to the driver via a visual warning device 64 and/or by providing audible warnings to the driver via an audible warning device 66.

Still yet further, the control apparatus 100 may also include a transmitter/receiver (transceiver) module 50 such as, for example, a radio frequency (RF) transmitter including one or more antennas 52 for wireless communication of automated deceleration requests, GPS data, one or more various vehicle configuration and/or condition data, or the like between the vehicles and one or more destinations such as, for example, to one or more wireless services (not shown) having a corresponding receiver and antenna. The transmitter/receiver (transceiver) module 50 may include various functional parts of sub portions operatively coupled with the control unit including for example a communication receiver portion, a global position sensor (GPS) receiver portion, and a communication transmitter. For communication of specific information and/or data, the communication receiver and transmitter portions may include one or more functional and/or operational communication interface portions as well.

The control apparatus 100 is operative to communicate the acquired data to the one or more receivers in a raw data form, that is without processing the data, in a processed form such as in a compressed form, in an encrypted form or both as may be necessary or desired. In this regard, the control apparatus 100 may combine selected ones of the vehicle parameter data values into processed data representative of higher-level vehicle condition data such as, for example, data from the multi-axis acceleration sensors 17 may be combined with the data from the steering angle sensor 18 to determine excessive curve speed event data. Other hybrid event data relatable to the vehicle and driver of the vehicle and obtainable from combining one or more selected raw data items form the sensors includes, for example and without limitation, excessive braking event data, excessive curve speed event data, lane departure warning event data, excessive lane departure event data, lane change without turn signal event data, loss of video tracking event data, LDW system disabled event data, distance alert event data, forward collision warning event data, haptic warning event data, collision mitigation braking event data, ATC event data, ESC event data, RSC event data, ABS event data, TPMS event data, engine system event data, average following distance event data, average fuel consumption event data, and average ACC usage event data. Importantly, however, and in accordance with the example embodiments described herein, the control apparatus 100 is operative to store the acquired image data of the driver and/or of the interior of the vehicle in the memory 124, and to selectively communicate the acquired driver and vehicle interior image data to the one or more receivers via the transceiver 50.

The vehicle control apparatus 100 of FIG. 1 is suitable for executing embodiments of one or more software systems or modules that perform vehicle operational and control strategies according to the subject application. The example vehicle ECU 120 of the vehicle control apparatus 100 may include a bus or other communication mechanism for communicating information, and a processor device 122 coupled with the bus for processing information. The computer system includes a main memory device 124, such as random access memory (RAM) or other dynamic storage device for storing information and instructions to be executed by the processor device 122, and read only memory (ROM) or other static storage device for storing static information and instructions for the processor device 122. Other storage devices may also suitably be provided for storing information and instructions as necessary or desired.

Instructions may be read into the main memory device 124 from another computer-readable medium, such as another storage device of via the transceiver 50. Execution of the sequences of instructions contained in main memory device 124 causes the processor device 122 to perform the process steps described herein. In an alternative implementation, hard-wired circuitry may be used in place of or in combination with software instructions to implement the invention. Thus implementations of the example embodiments are not limited to any specific combination of hardware circuitry and software.

In accordance with the descriptions herein, the term “computer-readable medium” as used herein refers to any non-transitory media that participates in providing instructions to the processor device 122 for execution. Such a non-transitory medium may take many forms, including but not limited to volatile and non-volatile media. Non-volatile media includes, for example, optical or magnetic disks. Volatile media includes dynamic memory for example and does not include transitory signals, carrier waves, or the like. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, PROM, and EPROM, a FLASH-EPROM, any other memory chip or cartridge, or any other tangible non-transitory medium from which a computer can read.

In addition and further in accordance with the descriptions herein, the term “logic”, as used herein with respect to the Figures, includes hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components.

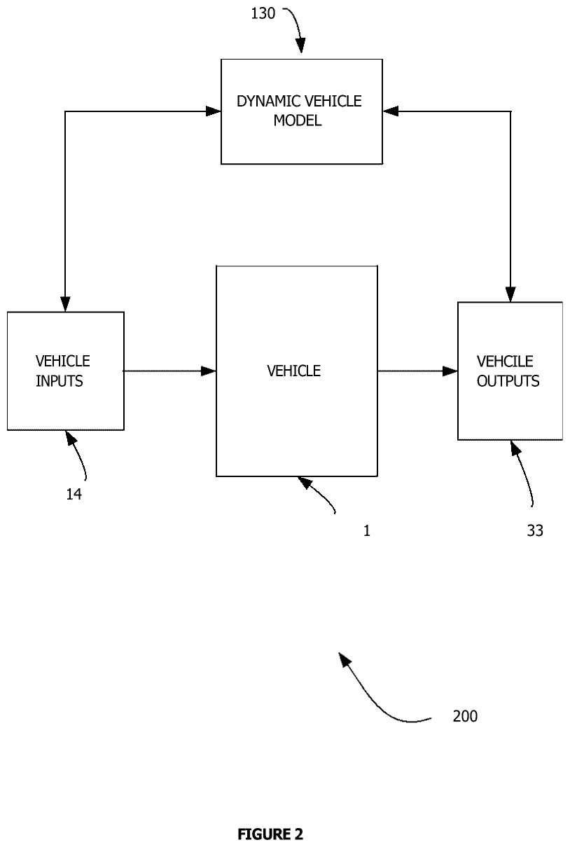

FIG. 2 illustrates is a schematic block diagram of an integrity checking system 200 according to an example embodiment. A vehicle 1 includes a plurality of control device components such as the input devices 14 described above in connection with FIG. 1, and a further plurality of control device components such as the output devices 33 also described above in connection with FIG. 1.

A dynamic vehicle model 130 is stored in the non-transitory memory device 124 (FIG. 1) and comprises vehicle operational state data representative of normal operational states of the vehicle controller. In accordance with the example embodiments, each of the normal operational states map one or more verified first signals obtained from control device components of the associated vehicle to verified second signals obtained from other control device components of the associated vehicle for the vehicle controller being operated in each of the normal operational states. In accordance with a particular example embodiment, a first normal operational state maps a verified first signal obtained from a first control device component 14 of the associated vehicle for the vehicle controller being operated in a first normal operational state to a verified second signal obtained from a second control device component 33 of the associated vehicle for the vehicle controller being operated in the first normal operational state.

The processor device 231 (FIG. 1) is operable to execute the integrity verification logic 132 (FIG. 1) to receive a first observed signal from the first control device component 14 of the associated vehicle for the vehicle controller being operated in the first normal operational state, and use the dynamic vehicle model to map the received first observed signal to a predicted second signal expected to be obtained from the second control device component for the vehicle controller being operated in the first normal operational state, and compare the predicted second signal with a second observed signal received from the second control device component.

The processor device 231 (FIG. 1) is further operable to execute the integrity verification logic 132 (FIG. 1) to verify the integrity of the first and second control device components based on a match within a predetermined range between the predicted second signal and the second observed signal, or generate a verification refute signal based on a mismatch within a predetermined range between the predicted second signal and the second observed signal. In accordance with a particular example embodiment, the verification refute signal is used by the vehicle controller to adjust a functional aspect of the associated vehicle.

In accordance with a further particular example embodiment, the dynamic vehicle model maps the received first observed signal to a predicted second signal expected to be obtained from the second control device component based on a framework such as a mathematical framework for example to express a causal chain that connects signals obtained from a first set of one or more control device components of the associated vehicle with signals obtained from a second set of control device components of the associated vehicle.

In accordance with a further particular example embodiment, the mapping and/or dependence between the first set of one or more control device components of the associated vehicle and the signals obtained from the second set of control device components of the associated vehicle may comprise nested functions and/or nested dependencies. In accordance with an example:

$$Output = function 3 ( function 2 ( function 1 ( input ) ) ) .$$

It is to be appreciated that this may also be taken over time, as an integral such as for example for input command histories, wherein:

$$Output = initial value + integral over time of ( function 3 ( function 2 ( function 1 ( input ( time ) ) ) ) .$$

This integral formulation applies to a braking the vehicle to a slow speed for example, as well as an “S” curve/steer command history input to change lane position.

At each stage, so within each function, the system may make some error—e.g. rounding, approximations, linearizations, quantization errors, modeling errors, noise, or the like, wherein the output only somewhat resembles what is expected given the input.

In the context of vehicles that use automatic driver assist systems (ADASs), for example:

ADAS result=actuator integrity (quality of derived actuator control signal (interpretation of sensor measurement (sensor integrity (true signal value))))+random noise

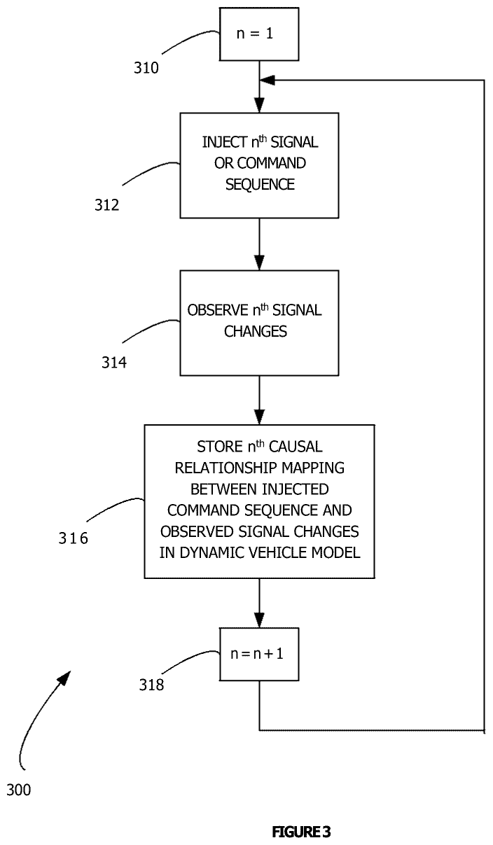

FIG. 3 is a flow diagram illustrating a method 300 of developing a dynamic vehicle model 130 in accordance with an embodiment. With reference now to that Figure, a refence counter is set at 310 to an initialization value.

A signal and/or command sequence is injected at 312 to the a vehicle controller of the associated vehicle. As described above, the Safety Direct® system observes, interprets, warns, and potentially, controls or assists in controlling the vehicle. The latter functions are safety relevant and should be verified. The example embodiments herein related to systems, methods, and computer readable medium that monitor functions for safety verification and/or for other reasons.

The method 300 includes observing at 314 signal changes on one or more control device components of the associated vehicle for the vehicle controller being operated in a known and/or approved safe “normal” operational state.

The method 300 further includes storing into the dynamic vehicle model 130 (FIG. 1) at 316 a casual relationship mapping between the injected command sequence and the observed signal changes.

The refence counter is incremented at 318 from the initialization value to a value different than the initialization value whereupon the process of 312-316 is repeated thereby developing the dynamic vehicle model 130 in accordance with an embodiment.

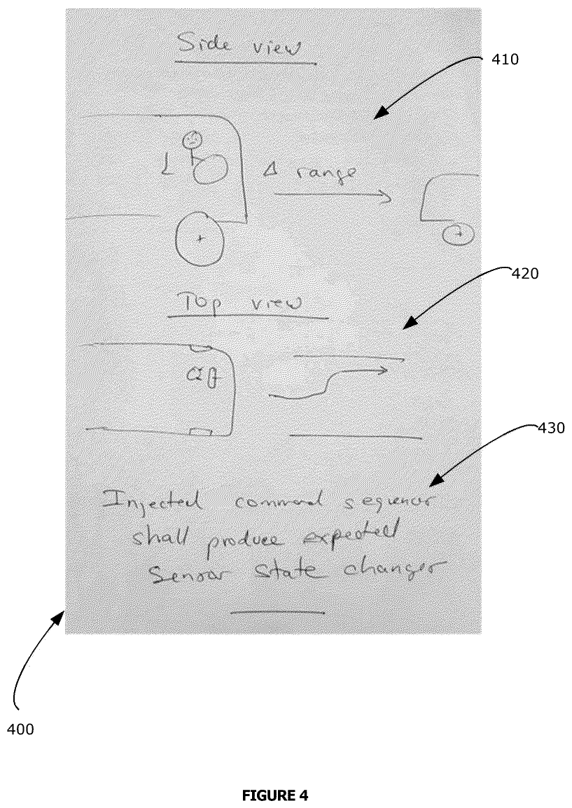

FIG. 4 shows a specific example 400 of the concept described above for developing the dynamic vehicle model 130 in accordance with an embodiment. A known, specially injected, command sequence is expected to produce expected sensor state changes. In the example of FIG. 4 it is supposed the vehicle acceleration and steering angle can be controlled. Changing either of these should lead to observable changes in the forward facing camera (FFC) image, perhaps radar signals and other values. It is supposed furthermore that a vehicle dynamic model that relates steering angle and acceleration to vehicle state is already stored in the memory device. For instance, it may be supposed a 1 second change in steering angle of 5 degrees to the left in initialized, and then a 1 second change of 5 degrees in the other direction is further initiated such as shown at 420 for example. The vehicle dynamic model would then predict an “S” shaped lane position change of some size, to the left, resuming our current yaw angle thereafter such as shown for expel at 420. Similarly, it may be supposed that a −0.25 (very gradual) m/sec-sec acceleration (very mild braking) may be applied for 2 seconds. This should lead to a −0.5 m/sec reduction in speed, about 2 km/h slower, and be detectable via the vehicle sensors (radar perhaps, if there is a target ahead, and via the speed sensor).

It is to be appreciated that it is preferred that these signals are injected only under safe conditions, e.g. with a straight road, sufficient distance to the vehicle ahead, no expected cut-in, no known vehicle behind, etc. Because the vehicle dynamic model is developable and may be changed as desired and/or as necessary, a margin of error must be tolerated. System integrity is verified by seeing that the output response sufficiently matches the input command. An analogy for this is an airplane pilot controlling the aileron before takeoff and seeing that it moves.

A second version of this is traversing a known section of roadway, this identified, measured, and labeled as a calibration scenario. In this known environment, we may expect, for example, a given measured lane width, perhaps particular radar returns, particular curve radii at various locations, etc. The system may thereby verify the system front end—that is, the sensors and the signal interpretation derived therefrom. Given GPS positional uncertainty, an alignment process and tolerance allowance will be necessary (e.g. ‘you can see the Empire State building if you stand exactly here’, but you are not sure of exactly where you are, so that what is seen may be first seen a bit later or earlier). In the road geometry example, for lane width, curvature, marking type, the system is tolerant to lane position and generally to location, but for the radar returns, sign and object detections, the lane position is considered (e.g. ‘you cannot yet see the stop sign or around the curve here unless you are in the rightmost part of the lane’).

Further in accordance with the above, ADAS systems typically may need to decide whether ADAS is possible on—from verified system integrity—a given road section. Presuming that system integrity is usually permitted in most cases, the system may look for vehicles that would ‘vote incorrectly,’ deviating from the majority can do ADAS or cannot do ADAS opinion. The system then may determine the specific reason for the deviation. Such a deviation analysis in accordance with the example embodiments herein help identify, e.g. poorly focused cameras, poor calibration, whereby the system might deem, both correctly and incorrectly, that it cannot help to assist and therefore enable ADAS functionality. It is correct that it shouldn't, as it does not have a well-focused image, but ‘incorrect’ in that it should have a good image, and so an issue that should be fixed.

This means that after the known environment has been traversed, a comparison of what the system measures/finds is done with what known good systems find/measure. Excessive deviations or lacunae—this depends on the tolerance of the specific ADAS system-lead to the vehicle being declared non-ADAS capable, perhaps with specific problem deviation diagnoses. It is advantageous to place such known calibration scenarios at the entrance of areas where ADAS shall be done.

For example, if most systems say that 80% of the last kilometer was ADAS capable and the subject system determines that it is only 38% is ADAS capable, then a deviation exists. Perhaps the weather conditions are different—wherein the system may then examine this—or perhaps the road was resurfaced and markings are not yet present—wherein the system may then examine this—and so on. Once possible ‘external’ hypotheses for the deviation being rejected, the subject system may look for and/or otherwise develop ‘internal’ hypotheses, and question the system integrity.

The intention here is thus that the subject system uses both internal and external aids, inputs, and known scenarios to verify system integrity. The system deals with each individually.

Internal commands may be implemented in accordance with the example embodiments.

The example embodiments include the system considering the environment of the vehicle and stored control signal sequence(s) for providing inputs. The vehicle driver, of course, is also able to control the vehicle and the system in accordance with further embodiments is also operable to consider verification of control by the vehicle driver relative to effectualization of the driver control by the vehicle.

A driver's primary inputs to a vehicle are the throttle, brake, and steering. Each involves motion of a control element (e.g. turning the steering wheel), a transmission or sensing of this motion (e.g. via gears or a mechanical linkage or a sensor), an interpretation of this motion (e.g. x degrees of control element change results in y change in speed or direction), an execution of this interpretation (e.g. the driver is requesting X pounds of brake pressure, and I, vehicle, produce y), and an ensuing result in the vehicle state. An intact command chain will produce the desired change for a given driver input, whereas a deteriorated command chain will produce less, no, or even an antithetical change for the given input.

It is to be noted that an internal change may also result from an ADAS system, e.g. via AEB, as distinct from the driver. Here the ADAS system calculates a desired change (e.g. lane position, speed adjustment, route or curve following), and gives this to essentially the same chain of command as described above. For either to work, the causal chain of command should be able to demonstrate integrity, and it is this that the system in accordance with further embodiments targets for verification. In this regard, the system in accordance with further embodiments determines whether the output, if present, corresponds to the input, along with any intermediate steps and values.

In the context of the Safety Direct® system there are often two (2) cameras being implemented, one facing forward (FFC) and the other inward (the Driver Facing Camera, DFC). The DFC is able to obtain steering wheel motion image data, that is used by the system as a first possible verification of driver command (if the steering angle is measured as changing, does the camera also see this, and is it proportional). This command is propagated down the chain, and should result in a directional change, visible with the camera (e.g. a changed yaw angle on a known to be straight road; the sun image, if visible, should also change location). If it does not, the system may infer a deteriorated, improperly calibrated, incorrectly serviced, steering system.

The system in accordance with further embodiments may not be able to directly observe the driver's mechanical input to control the speed. Instead, it begins with the throttle angle measurement or the brake pressure measurement. That is, the system monitors/receives an ADAS command or the driver throttle angle/brake pressure via a sensor. The system then determines whether these commands produce a corresponding, ‘command chain is intact’, vehicle response.

For brake applications, the system is operable to visually monitor for vehicle pitching downward (the forward looking camera's view and perspective of the lane lines changes—this is a sensitive measurement, to ˜tenth of a degree accuracy). The system is further operable to secondarily monitor for a speed change. It is to be understood that the monitoring for a speed change may take a bit of time to realize for a heavy commercial vehicle. That is, the system optically monitors the dynamically sensitive FLC pitch angle, which may have been calibrated earlier, over time, so a deceleration of x m/sec-sec corresponds to a pitch angle change of y degrees forward.

In accordance the embodiments herein the pairs of measurements to compare via the dynamic vehicle model may include but are not necessarily limited to one or more of:
DFC image and measured steering wheel motion;
DFC image and possibly visible shift lever activity and position;
FFC image detects forward pitching to verify braking integrity;
FFC image detects yaw angle and verifies steering integrity;
FFC image shows vehicle present and radar signal indicating object presence and distance;
Commanded speed change vs. optical measurement of dashed line ends to get speed;
FFC image detects yaw angle and lane position and verifies differential braking;
GPS position and warning activation;
Warning system integrity-DFC verifies driver attention to warning signal;
Known environment produces expected sensor signals; and/or
Parallel sensors, e.g. camera and radar object detection, and their disagreement rate.

The system in accordance the embodiments herein is further operable using “external commands’ that may be described in words as “you should measure this much” with regard to the sensor integrity checking.

This corresponds to the environment that provides the known calibration signals scenario. For instance, numerous vehicles may have traversed a section of highway, measuring the lane width there, the marking type, the radius, etc. Perhaps there is a known radar reflection—e.g. a guardrail in a curve that is then subsequently ignored—that the preceding vehicles nearly all detect, and this at say 50 meters away. If a subject vehicle does not detect (especially repeatedly) the guardrail, or first detects it at only 20 meters away (and generally does so for other known objects also), then the radar (or lidar) distance sensor is likely compromised.

The above may be inverted for observation of the driver's behavior. If the driver slows down, though there is no clear reason for this—no sensor detects low friction, an object ahead, a narrowed lane, etc, so a restriction of some type. The mismatch—the sensors should have found the cause of the slowdown—indicates a sensor malfunction, a sensor miss versus a sensor false positive.

Rumble strips may be used in example embodiments as a special calibration test, wherein a zero lane distance should result in an accelerometer signal being received.

In further addition, the system may use the radar measurements to verify and adjust correct tuning of the braking system such as for example at a high level, you could use a similar methodology as described to configure/parameterize brake gain “on the fly” for our open-loop American air brake system. Given a known ADAS scenario (+ target), and a certain brake request, the system is operable to use the vehicle speed reduction and target kinematic information from the radar to determine how much deceleration was actually achieved through the known brake request, and then make adjustments to the brake gains to get closer to the desired deceleration. The system in accordance with an embodiment may be operable therefore to constantly try to close the loop on the otherwise open-loop system with and/or by using the capabilities of the ADAS detections.

It is to be appreciated that the system may be operable to perform integrity checks to and/or on any electronically sensed system of the associated vehicle.

It is further to be appreciated that the system may verify the driver inputs that are sensed and that cause vehicle motion. Brake system senses a certain brake pedal apply, the other sensors verify that this results in a corresponding vehicle motion change. Limited to low dynamic events (no ABS, no stability).

It is still further to be appreciated that the system may also compare driver inputs (brake pedal) to system inputs (pressure request) to gauge that the two correlate with each other. This is extendable to cover certain aspects of the brake controller (actual realized braking/yaw) as well.

It is yet still further to be appreciated that the system may repeat this often enough to account for brake wear, change in valve performance, or air leakage throughout the life of the vehicle.

Overall therefore, the subject application provides systems, methods, and computer readable mediums for verification/correction/integrity check of a causal vehicular sensing, interpretation, command, control and measurement chain, characterized in that given a known input, a contradiction, omission, disagreement, failure, or opposition of an expected output or parallel monitored input is observed; an element(s) of the causal chain is flagged as defective, incorrectly calibrated, blocked, dysfunctional, broken; and operations dependent on the intact causal chain are: not executed, executed in a reduced manner, and/or a correction is initiated.

It is further to be appreciated that the integrity verification apparatus may interact with one or more further devices or vehicle systems for adjusting braking functional aspects of the vehicle, throttle functional aspects of the vehicle, and/or steering functional aspects of the vehicle based on the determined integrity of the control device components interfacing the vehicle controller of the associated vehicle with the physical environment of the associated vehicle during operation of the vehicle. In addition, the integrity verification apparatus may interact with the driver using functional aspects of the vehicle by providing visual warnings to the driver via a visual warning device 64 and/or by providing audible warnings to the driver via an audible warning device 66.

In accordance with various embodiments herein, the adjusting the functional aspect of the vehicle based on the determined integrity of the control device components of the associated vehicle comprises one or more of adjusting a content of a warning signal generated by the vehicle for warning the driver of potential danger relating to the vehicle operation, adjusting a timing of a warning signal generated by the vehicle for warning the driver of potential danger relating to the vehicle operation, adjusting a format of a warning signal generated by the vehicle for warning the driver of potential danger relating to the vehicle operation, adjusting a style of a warning signal generated by the vehicle for warning the driver of potential danger relating to the vehicle operation, and/or adjusting a parameter of one or more driver assistance systems of the vehicle.

In accordance with various embodiments herein, the adjusting the functional aspect of the vehicle comprises adjusting the functional aspect of the vehicle based on determined integrity of the control device components of the associated vehicle to a maneuver of the vehicle.

In accordance with various embodiments herein, the adjusting the functional aspect of the vehicle comprises adjusting the functional aspect of the vehicle based on a determined integrity of the control device components of the associated vehicle.

In accordance with various embodiments herein, the adjusting the functional aspect of the vehicle comprises adjusting a further functional aspect of the vehicle based on determined integrity of the control device components of the associated vehicle.

It is to be understood that other embodiments will be utilized and structural and functional changes will be made without departing from the scope of the present invention. The foregoing descriptions of embodiments of the present invention have been presented for the purposes of illustration and description. It is not intended to be exhaustive or to limit the invention to the precise forms disclosed. Accordingly, many modifications and variations are possible in light of the above teachings. It is therefore intended that the scope of the invention be limited not by this detailed description.

1. An integrity verification apparatus operable in an associated vehicle to verify the integrity of control device components interfacing a vehicle controller of the associated vehicle with a physical environment of the associated vehicle, the integrity verification apparatus comprising:
a processor device;
a non-transitory memory device operatively coupled with the processor device;
a dynamic vehicle model stored in the non-transitory memory device, the dynamic vehicle model comprising vehicle operational state data representative of normal operational states of the vehicle controller, wherein a first normal operational state maps a verified first signal obtained from a first control device component of the associated vehicle for the vehicle controller being operated in the first normal operational state to a verified second signal obtained from a second control device component of the associated vehicle for the vehicle controller being operated in the first normal operational state; and
integrity verification logic stored in the non-transitory memory device,
wherein the processor device is operable to execute the integrity verification logic to:
receive a first observed signal from the first control device component of the associated vehicle for the vehicle controller being operated in the first normal operational state;
use the dynamic vehicle model to map the received first observed signal to a predicted second signal expected to be obtained from the second control device component for the vehicle controller being operated in the first normal operational state;
compare the predicted second signal with a second observed signal received from the second control device component; and
verify the integrity of the first and second control device components based on a match within a predetermined range between the predicted second signal and the second observed signal, or
generate a verification refute signal based on a mismatch within a predetermined range between the predicted second signal and the second observed signal, wherein the verification refute signal is used by the vehicle controller to adjust a functional aspect of the associated vehicle.

2. The integrity verification apparatus according to claim 1, wherein the processor device is operable to execute the integrity verification logic to:
generate the verification refute signal based on the mismatch within a predetermined range between the predicted second signal and the second observed signal, wherein the verification refute signal is used by the vehicle controller to adjust one or more of:
a content of a warning signal generated by the vehicle controller for warning the driver of potential danger relating to the vehicle operation;
a timing of a warning signal generated by the vehicle controller for warning the driver of potential danger relating to the vehicle operation;
a format of a warning signal generated by the vehicle controller for warning the driver of potential danger relating to the vehicle operation;
a style of a warning signal generated by the vehicle controller for warning the driver of potential danger relating to the vehicle operation; and/or
a parameter of one or more automatic driver assistance systems (ADASs) of the associated vehicle.

3. The integrity verification apparatus according to claim 1, wherein the processor device is operable to execute the integrity verification logic to:
receive image data as the first observed signal from the first control device component comprising an imaging device; and
receive sensor data as the second observed signal from the second control device component comprising one or more of an accelerometer, a steering wheel angle position sensor, a brake pedal position sensor, a wheel speed sensor, a forward distance sensor, a rear distance sensor, and/or an engine speed or condition sensor.

4. The integrity verification apparatus according to claim 3, wherein the processor device is operable to execute the integrity verification logic to:
generate the verification refute signal based on the mismatch within a predetermined range between the predicted second signal and the sensor data received as the second observed signal, wherein the verification refute signal is used by the vehicle controller to adjust one or more of:
a content of a warning signal generated by the vehicle controller for warning the driver of potential danger relating to the vehicle operation;
a timing of a warning signal generated by the vehicle controller for warning the driver of potential danger relating to the vehicle operation;
a format of a warning signal generated by the vehicle controller for warning the driver of potential danger relating to the vehicle operation;
a style of a warning signal generated by the vehicle controller for warning the driver of potential danger relating to the vehicle operation; and/or
a parameter of one or more automatic driver assistance systems (ADASs) of the associated vehicle.

5. The integrity verification apparatus according to claim 1, wherein the processor device is operable to execute the integrity verification logic to:
receive driver image data as the first observed signal from the first control device component comprising an imaging device oriented to obtain an image of the driver of the associated vehicle; and
receive sensor data as the second observed signal from the second control device component comprising one or more of an accelerometer, a steering wheel angle position sensor, a brake pedal position sensor, a wheel speed sensor, a forward distance sensor, a rear distance sensor, and/or an engine speed or condition sensor.

6. The integrity verification apparatus according to claim 1, wherein the processor device is operable to execute the integrity verification logic to:
receive roadway image data as the first observed signal from the first control device component comprising an imaging device oriented to obtain an image of the roadway ahead of the associated vehicle; and
receive sensor data as the second observed signal from the second control device component comprising one or more of an accelerometer, a steering wheel angle position sensor, a brake pedal position sensor, a wheel speed sensor, a forward distance sensor, a rear distance sensor, and/or an engine speed or condition sensor.

7. The integrity verification apparatus according to claim 1, wherein the processor device is operable to execute the integrity verification logic to:
generate the verification refute signal based on the mismatch within a predetermined range between the predicted second signal and the second observed signal, wherein the verification refute signal is used by the vehicle controller to:
terminate operation of one or more automatic driver assistance systems (ADASs) of the associated vehicle;
execute operation of the one or more ADASs of the associated vehicle in a reduced manner; and/or
initiate a correction in the one or more ADASs of the associated vehicle.

8. A method of verifying integrity of control device components interfacing a vehicle controller of an associated vehicle with a physical environment of the associated vehicle, the method comprising:
storing a dynamic vehicle model in a non-transitory memory device, the dynamic vehicle model comprising vehicle operational state data representative of normal operational states of the vehicle controller, wherein a first normal operational state maps a verified first signal obtained from a first control device component of the associated vehicle for the vehicle controller being operated in the first normal operational state to a verified second signal obtained from a second control device component of the associated vehicle for the vehicle controller being operated in the first normal operational state;
storing integrity verification logic data in the non-transitory memory device; and
executing the integrity verification logic by a processor device to:
receive a first observed signal from the first control device component of the associated vehicle for the vehicle controller being operated in the first normal operational state;
use the dynamic vehicle model to map the received first observed signal to a predicted second signal expected to be obtained from the second control device component for the vehicle controller being operated in the first normal operational state;
compare the predicted second signal with a second observed signal received from the second control device component; and
verify the integrity of the first and second control device components based on a match within a predetermined range between the predicted second signal and the second observed signal, or
generate a verification refute signal based on a mismatch within a predetermined range between the predicted second signal and the second observed signal, wherein the verification refute signal is used by the vehicle controller to adjust a functional aspect of the associated vehicle.

9. The method according to claim 8, further comprising executing the integrity verification logic by the processor device to:
generate the verification refute signal based on the mismatch within a predetermined range between the predicted second signal and the second observed signal, wherein the verification refute signal is used by the vehicle controller to adjust one or more of:
a content of a warning signal generated by the vehicle controller for warning the driver of potential danger relating to the vehicle operation;
a timing of a warning signal generated by the vehicle controller for warning the driver of potential danger relating to the vehicle operation;
a format of a warning signal generated by the vehicle controller for warning the driver of potential danger relating to the vehicle operation;
a style of a warning signal generated by the vehicle controller for warning the driver of potential danger relating to the vehicle operation; and/or
a parameter of one or more automatic driver assistance systems (ADASs) of the associated vehicle.

10. The method according to claim 8, further comprising executing the integrity verification logic by the processor device to:
receive image data as the first observed signal from the first control device component comprising an imaging device; and
receive sensor data as the second observed signal from the second control device component comprising one or more of an accelerometer, a steering wheel angle position sensor, a brake pedal position sensor, a wheel speed sensor, a forward distance sensor, a rear distance sensor, and/or an engine speed or condition sensor.

11. The method according to claim 10, further comprising executing the integrity verification logic by the processor device to:
generate the verification refute signal based on the mismatch within a predetermined range between the predicted second signal and the sensor data received as the second observed signal, wherein the verification refute signal is used by the vehicle controller to adjust one or more of:
a content of a warning signal generated by the vehicle controller for warning the driver of potential danger relating to the vehicle operation;
a timing of a warning signal generated by the vehicle controller for warning the driver of potential danger relating to the vehicle operation;
a format of a warning signal generated by the vehicle controller for warning the driver of potential danger relating to the vehicle operation;
a style of a warning signal generated by the vehicle controller for warning the driver of potential danger relating to the vehicle operation; and/or
a parameter of one or more automatic driver assistance systems (ADASs) of the associated vehicle.

12. The method according to claim 8, further comprising executing the integrity verification logic by the processor device to:
receive driver image data as the first observed signal from the first control device component comprising an imaging device oriented to obtain an image of the driver of the associated vehicle; and
receive sensor data as the second observed signal from the second control device component comprising one or more of an accelerometer, a steering wheel angle position sensor, a brake pedal position sensor, a wheel speed sensor, a forward distance sensor, a rear distance sensor, and/or an engine speed or condition sensor.

13. The method according to claim 8, further comprising executing the integrity verification logic by the processor device to:
receive roadway image data as the first observed signal from the first control device component comprising an imaging device oriented to obtain an image of the roadway ahead of the associated vehicle; and
receive sensor data as the second observed signal from the second control device component comprising one or more of an accelerometer, a steering wheel angle position sensor, a brake pedal position sensor, a wheel speed sensor, a forward distance sensor, a rear distance sensor, and/or an engine speed or condition sensor.

14. The method according to claim 8, further comprising executing the integrity verification logic by the processor device to:
generate the verification refute signal based on the mismatch within a predetermined range between the predicted second signal and the second observed signal, wherein the verification refute signal is used by the vehicle controller to:
terminate operation of one or more automatic driver assistance systems (ADASs) of the associated vehicle;
execute operation of the one or more ADASs of the associated vehicle in a reduced manner; and/or
initiate a correction in the one or more ADASs of the associated vehicle.
